(19) United States
(12) Patent Application Publication
(10) Pub. No.: US 2017/0171601 A1
(43) Pub. Date: Jun. 15, 2017

(54) BULLET SCREEN LOADING METHOD AND ELECTRONIC DEVICE

(71) Applicants: LE HOLDINGS (BEIJING) CO., LTD., Beijing (CN); LE SHI INTERNET INFORMATION & TECHNOLOGY CORP. BEIJING, Beijing (CN)

(72) Inventor: Yousheng CUI, Beijing (CN)

(73) Assignees: LE HOLDINGS (BEIJING) CO., LTD., Beijing (CN); LE SHI INTERNET INFORMATION & TECHNOLOGY CORP., BE IJING, Beijing (CN)

(21) Appl. No.: 15/243,617

(22) Filed: Aug. 22, 2016

Related U.S. Application Data
(63) Continuation of application No. PCT/CN2016/089562, filed on Jul. 10, 2016.

(30) Foreign Application Priority Data
Dec. 11, 2015 (CN) 201510918462.6

(51) Int. Cl. H04N 21/431; H04N 21/845; H04N 21/472

(52) U.S. Cl. CPC H04N 21/4312; H04N 21/47217; H04N 21/8456

(57) ABSTRACT

Embodiments of the present disclosure relate to the field of bullet screen loading, and a user terminal, a server and a bullet screen loading method and system are disclosed. The user terminal includes: a sending apparatus, configured to send a bullet screen request to a server at a preset time interval during playback of a video; a receiving apparatus, configured to receive bullet screen data determined by the server according to a time at which the sending apparatus sends the bullet screen request; a display apparatus, configured to display the video; and a control apparatus, configured to control the display apparatus to display the bullet screen data received by the receiving apparatus.

### CROSS-REFERENCE TO RELATED APPLICATIONS

The present disclosure is a continuation of PCT application No. PCT/CN2016/089562 submitted on Jul. 10, 2016, and the present disclosure claims this application is based upon and claims priority to Chinese Patent Application No. 201510918462.6, filed before Chinese Patent Office on Dec. 11, 2015, the entire contents of which are incorporated herein by reference.

### TECHNICAL FIELD

Embodiments of the present disclosure relate to the field of bullet screen loading, and more particularly, to a user terminal, a server, and a bullet screen loading method and system.

### BACKGROUND

Bullet screen videos have been known to audience, and it is very important for bullet screen videos to optimize loading and display of bullet screens.

In the prior art, during bullet screen loading, a user terminal sends a request to a server, the server sends all bullet screens that are stored and related to the video to the user terminal, the user terminal stores the bullet screens sent by the server in a local memory, and plays the bullets curtain according to the time order.

Considering the performance of the server, in the prior art, the number of bullet screens sent by the server to the user terminal at a time is limited. For example, 3000 bullet screens are sent each time, and the 3000 bullet screens cover bullet screens at any time in a time period from the beginning of the video to the end. In a case in which the number of bullet screens is great, for example, over ten thousands, which greatly exceeds 3000, and the number of bullet screens that can be presented to users is merely 3000. That is, the users may merely see the 3000 bullet screens from the video playback to the end, causing inadequate loading of bullet screens. In addition, screen usage of bullet screen display is merely 40% to 60%, which is not high enough.

In addition, the server sends all the bullet screens to the user terminal, which causes large storage of the user terminal, thereby increasing the performance consumption of the user terminal.

### SUMMARY

Objectives of embodiments of the present disclosure are to provide a user terminal, a server, and a bullet screen loading method and system, which synthetically take into account the performance consumption of the server and the user terminal, and improve screen usage of bullet screens.

According to the first aspect, an embodiment of the present disclosure further provides a bullet screen loading method, including: sending a bullet screen request to a server at a preset time interval during playback of a video; receiving bullet screen data determined by the server according to a time at which the sending apparatus sends the bullet screen request; and controlling to display the received bullet screen data.

According to the second aspect, part of the embodiments of the present disclosure further provide a bullet screen loading method, including: storing bullet screen data of multiple time periods during playback of a video; receiving a bullet screen request sent by a user terminal; determining, according to a time at which the user terminal sends the bullet screen request, bullet screen data of a time period within which the time falls; and sending the determined bullet screen data to the user terminal.

According to a second aspect, an embodiment of the disclosure further provides a non-transitory computer-readable storage medium, which stores computer executable instructions, where the computer executable instructions can be executed any foregoing bullet curtain loading method of this application.

According to a third aspect, an embodiment of the disclosure further provides an electronic device, including: at least one processor; and a memory in communication connection with the at least one processor. The memory stores instructions that can be executed by the at least one processor, and execution of the instructions by the at least one processor, causes the at least one processor to perform any foregoing bullet curtain loading method of this application.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed. In the accompanying drawings:

FIG. 1 is a structural block diagram illustrating a server according to an embodiment of the present disclosure;

FIG. 2 is a structural block diagram illustrating a user terminal according to an embodiment of the present disclosure;

FIG. 3 illustrates a bullet screen loading method based on a user terminal according to an embodiment of the present disclosure;

FIG. 4 illustrates a bullet screen loading method based on a server according to an embodiment of the present disclosure; and

FIG. 5 is a schematic structural diagram of hardware of an electronic device for executing a bullet curtain loading method according to another embodiment of this application.

### DETAILED DESCRIPTION

Specific embodiments of the present disclosure are described hereinafter in detail with reference to the accompanying drawings. It should be understood that the specific embodiments described hereinafter are merely used to describe and explain the present disclosure, not to limit the present disclosure.

FIG. 1 is a structural block diagram illustrating a server according to an embodiment of the present disclosure. As illustrated in FIG. 1, the present disclosure provides a server, including: a storage module 210, configured to store bullet screen data of multiple time periods during playback of a video; a receiving module 230, configured to receive a bullet screen request sent by a user terminal; a control module 220, configured to determine, according to a time at which the user terminal sends the bullet screen request, bullet screen data of a time period within which the time falls; and a sending module 240, configured to send the determined bullet screen data to the user terminal.

Specifically, the storage module 210 stores the bullet screen data related to the video in segments according to the time periods. For example, bullet screen data in the first (including the first minute) to the fifth minute (not including the fifth minute) is stored as the first time period bullet screen data, bullet screen data in the fifth (including the fifth minute) to the tenth minute (not including the tenth minute) is stored as the second time period bullet screen data, and bullet screen data storage is performed in the same manner. It should be understood that the 5 minutes herein are merely used as an example, and not to limit the present disclosure. The time periods segmented for storing the bullet screen data may be adjusted correspondingly according to a time length of the video, or may be adjusted correspondingly according to the time interval of the bullet screen request sent by the user terminal.

Each time period bullet screen data may include one or more bullet screens, and a manner of the storage module 210 to store the bullet screens is: bullet screen content has a one-to-one correspondence with playback time of the bullet screen content. After the receiving module 230 receives the request sent by the user terminal, the control module 220 may determine, according to the time at which the user terminal sends the bullet screen request, the time period within which the sending time falls. For example, if the user terminal sends the bullet screen in the first minute after the video is played, the control module 220 may determine that the user terminal requires for the first period bullet screen data, then the sending module 240 sends the determined first period bullet screen data to the user terminal.

In addition, an upper limit value may be set for the number of bullet screens covered in each time period bullet screen data. For example, the number may be set as 1500, so that the bullet screen data sent by the server to the user terminal is not excessively large, further reducing the performance consumption of the server.

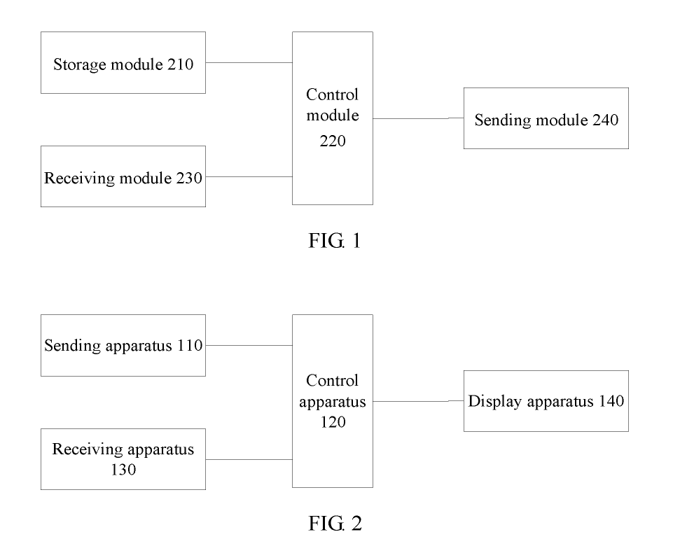

FIG. 2 is a structural block diagram of a user terminal according to an embodiment of the present disclosure. As shown in FIG. 2, the present disclosure further provides a user terminal, including: a sending apparatus 110, configured to send a bullet screen request to a server at a preset time interval during playback of a video; a receiving apparatus 130, configured to receive bullet screen data determined by the server according to a time at which the sending apparatus sends the bullet screen request; a display apparatus 140, configured to display the video; and a control apparatus 120, configured to control the display apparatus 140 to display the bullet screen data received by the receiving apparatus. The bullet screen request is sent to the server at a preset time interval, so as to increase the number of times of bullet screen requests, further increase the number of bullet screens displayed in each time period, and reduce carry capacity of the user terminal at a time, thereby reducing the performance consumption of the user terminal.

In an embodiment, the terminal may further include a storage apparatus (not shown in the figure), configured to store the bullet screen data received by the receiving apparatus and a display time of each bullet screen in the bullet screen data.

Specifically, for bullet screen videos, the sending apparatus 110 may be set to send a bullet screen request to the server at a preset time interval. For example, the bullet screen request is sent to the server every 5 minutes since the beginning of the video playback, and the predetermined time should be corresponding to a time period of the bullet screen data stored in the server. For example, the predetermined time herein is set as 5 minutes, and the time period segmented for the storage module 210 in the server to store the bullet screen data should be set as 5 minutes.

After the sending apparatus 110 sends the bullet screen request to the server, the control module 220 of the server may determine, according to a time at which the user terminal sends the bullet screen request, a time period within which the sending time falls, and further send bullet screen data corresponding to the time period to the receiving apparatus 130. After the receiving apparatus 130 receives the bullet screen data, the control apparatus 120 controls the display apparatus 140 to display the bullet screen content responsive to the bullet screen according to a playback time of each bullet screen.

The bullet screen data received by the receiving apparatus 130 each time may include many bullet screens. It can be known, according to an upper limit value (for example, 1500) of the number of bullet screens included in each specific time period bullet screen data in the server, that the number of bullet screens displayed at a time per minute on a display screen of the display apparatus 140 may be up to 300 (1500/5 minutes). In this case, the display of the bullet screen content on the display screen may be optimized. For example, when the number of the bullet screens is less, the bullet screen content is displayed on the top of the display screen, and when the number of the bullet screens is great, the bullet screen content fully covers the display screen. In addition, the bullet screens displayed on the display screen may conform to a rule of being played from the top to the bottom, the bullet screen content is set to fill each line one by one, that is, bullet screen content of the second line is displayed after bullet screen content of the first line is filled, and so forth, further improving screen usage of the display apparatus 140, so that the screen usage of the bullet screen content may be up to 90%, thereby increasing user experience.

Correspondingly, an embodiment of the present disclosure further provides a bullet screen loading system, including: the user terminal, and the server, where the user terminal sends a bullet screen request to the server at a preset time interval during playback of a video; the server determines, according to a time at which the user terminal sends the bullet screen request, bullet screen data of a time period within which the time falls, and sends the determined bullet screen data to the user terminal; and the user terminal receives the bullet screen data sent by the server, and displays the received bullet screen data on the display screen.

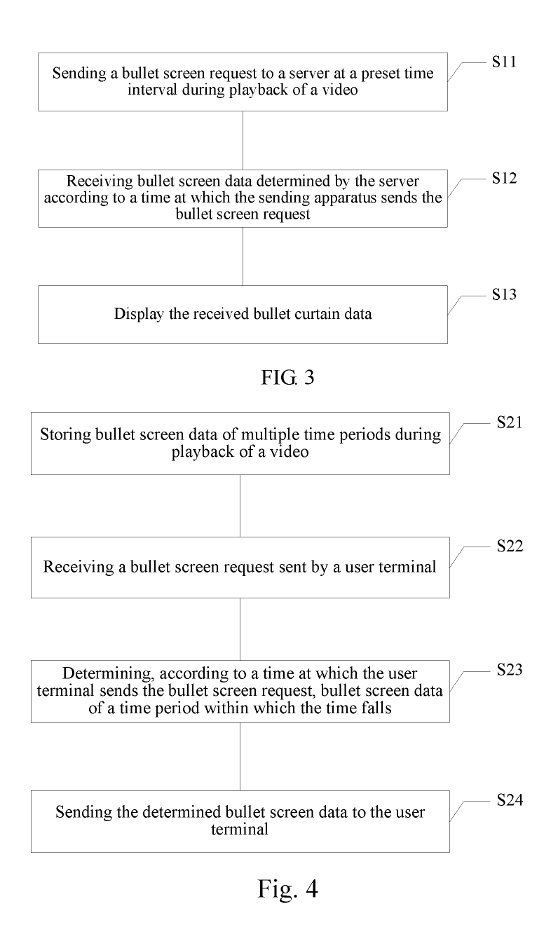

FIG. 3 is a bullet screen loading method based on a user terminal according to an embodiment of the present disclosure. As shown in FIG. 3, the present disclosure further provides a bullet screen loading method, including: sending a bullet screen request to a server at a preset time interval during playback of a video (step S11); receiving bullet screen data determined by the server according to a time at which the sending apparatus sends the bullet screen request (step S12); and controlling the display apparatus to display the received bullet screen data (step S13).

Further, the method may further include: storing the received bullet screen data and a display time of each bullet screen in the bullet screen data. In an embodiment, the method further includes: controlling the display apparatus to display each bullet screen according to the display time of the bullet screen.

Specifically, for bullet screen videos, it may be set to send a bullet screen request to the server at a preset time interval. For example, the bullet screen request is sent to the server every 5 minutes since the beginning of the video playback, and the predetermined time should be corresponding to a time period of the bullet screen data stored in the server. For example, the predetermined time herein is set as 5 minutes, and the time period segmented to store the bullet screen data in the server should be set as 5 minutes.

After the bullet screen request is sent to the server, the server may determine, according to a time at which the user terminal sends the bullet screen request, a time period within which the sending time falls, and further send bullet screen data corresponding to the time period to the user terminal. After the user terminal receives the bullet screen data, the display apparatus is controlled to display bullet screen content responsive to the bullet screen according to a playback time of each bullet screen.

The bullet screen data received each time may include many bullet screens. It can be known, according to an upper limit value (for example, 1500) of the number of bullet screens included in each specific time period bullet screen data in the server, that the number of bullet screens displayed at a time per minute on a display screen may be up to 300 (1500/5 minutes). In this case, the display of the bullet screen content on the display screen may be optimized. For example, when the number of the bullet screens is less, the bullet screen content is displayed on the top of the display screen, and when the number of the bullet screens is great, the bullet screen content fully covers the display screen. In addition, the bullet screens displayed on the display screen may conform to a rule of being played from the top to the bottom, the bullet screen content is set to fill each line one by one, that is, bullet screen content of the second line is displayed after bullet screen content of the first line is filled, and so forth, further improving screen usage of the display apparatus 140, so that the screen usage of the bullet screen content may be up to 90%, thereby increasing user experience.

FIG. 4 is a bullet screen loading method based on a server according to an embodiment of the present disclosure. As shown in FIG. 4, the present disclosure further provides a bullet screen loading method, including: storing bullet screen data of multiple time periods during playback of a video (step S21); receiving a bullet screen request sent by a user terminal (step S22); determining, according to a time at which the user terminal sends the bullet screen request, bullet screen data of a time period within which the time falls (step S23); and sending the determined bullet screen data to the user terminal (step S24).

Specifically, the bullet screen data related to the video may be stored in segments according to the time periods. For example, bullet screen data in the first (including the first minute) to the fifth minute (not including the fifth minute) is stored as the first time period bullet screen data, bullet screen data in the fifth (including the fifth minute) to the tenth minute (not including the tenth minute) is stored as the second time period bullet screen data, and bullet screen data storage is performed in the same manner. It should be understood that the 5 minutes herein are merely used as an example, and not to limit the present disclosure. The time periods segmented for storing bullet screen data may be adjusted correspondingly according to a time length of the video, or may be adjusted correspondingly according to the time interval of the bullet screen request sent by the user terminal.

Each time period bullet screen data may include one or more bullet screens, and a manner of storing the bullet screens is: bullet screen content has a one-to-one correspondence with playback time of the bullet screen content. After the bullet screen request sent by the user terminal is received, according to the time at which the user terminal sends the bullet screen request, a time period within which the sending time falls determined. For example, if the user terminal sends the bullet screen in the first minute after the video is played, it is determined that the user terminal requires for the first period bullet screen data, then the determined first period bullet screen data is sent to the user terminal.

In addition, an upper limit value may be set for the number of bullet screens covered in each time period bullet screen data. For example, the number may be set as 1500, so that the bullet screen data sent by the server to the user terminal is not excessively large, further reducing the performance consumption of the server.

By means of the user terminal, the server, and the bullet screen loading method and system provided in the embodiments of the present disclosure, the number of bullet screens sent by a server to a user terminal at a time is reduced, so as to reduce the performance consumption of the server and the user terminal at the same time, and improve screen usage of bullet screens.

According to an embodiment of the present disclosure, there is provided with a non-transitory computer-readable storage medium storing executable instructions that, when executed by an electronic device, cause the electronic device to perform the bullet curtain loading method in any one of the foregoing method embodiments.

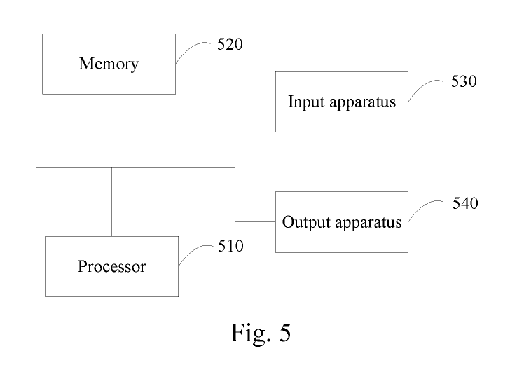

FIG. 5 illustrates a schematic hardware diagram of an electronic device for performing bullet curtain loading method according to another embodiment of this application. As shown in FIG. 5, the electronic device includes: one or more processors 510 and a memory 520, FIG. 5 shows one processor 410 as an example.

The device for executing the bullet curtain loading method can further include: an input apparatus 530 and an output apparatus 540.

The processor 510, the memory 520, the input apparatus 530, and the output apparatus 540 can be connected by means of a bus or in other manners. A connection by means of a bus is used as an example in FIG. 5.

Memory 520 is a non-transitory computer-readable medium for storing a non-transitory software program, a non-transitory computer-readable program and module, for example the program instructions/module for performing the bullet curtain loading method in the embodiments of this disclosure (for example, the storage module 210, the control module 220, the receiving module 230, and the sending module 240 shown in FIG. 1 ). The processor 510 can operate the various functions and data processing of a server to implement the bullet curtain loading method of the foregoing method embodiments, by executing non-transitory software programs, instructions and modules stored in the memory 520.

The memory 520 can include a program storage area and a data storage area. Among them, the program storage area may store operation system, application programs of at least one function; the data storage area may store generated data during operation of the electronic apparatus for processing bullet curtain loading, and the like. In addition, the memory 520 may include a high speed random access memory, and a non-transitory storage medium, for example at least one disk storage device, flash storage device, or another non-transitory solid-state storage device. In some embodiments, the memory 520 may include a storage medium that is remote to the processor 510. The remote storage medium may be connected, via a network, to the apparatus for processing bullet curtain loading. The examples of such as network include but not limited to Internet, enterprise intranet, local area network, mobile telecommunication network and a combination thereof.

The input apparatus 530 can receive input number or byte information, and can generate input key information relating to user setting and functional control of the electronic apparatus for performing the bullet curtain loading described in the above embodiments. The output apparatus 540 may include a display device such as a display screen.

The one or more modules stored in the memory 520 that, when executed by the one or more processors 510, can perform the bullet curtain loading method in any one of the foregoing method embodiments.

The above products can perform any of the above described methods, and have corresponding functional modules and effects. Details that are not disclosed in this embodiment can be understood by reference to the above method embodiments of the present disclosure.

An electronic apparatus of the present disclosure can exist in a varied form and includes but not limited to:

A mobile communication device which is capable of performing mobile communication function and having a main purpose for audio or data communication. Such a mobile communication device includes: a smart phone (e.g. iPhone), a multimedia phone, a functional mobile phone and a low-end mobile phone etc.

A super-mobile personal computer which belongs to the field of a personal computer and has calculation and processing functions, and in general can access to a mobile network. Such a terminal device includes: a PDA, a MID and a UMPC etc., for example iPad.

A portable entertainment device which is capable of displaying and playing multimedia content. Such a device includes: an audio player, a video player (e.g. iPod), a handheld game console, an electronic book, a smart toy and a portable automotive navigation device.

A server which can provide calculation service and can include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.

Other electronic apparatus that is capable of data exchange.

The above described apparatus embodiments are for illustration purpose only, in which modules/units that are described above as separate elements may be physically separate or not separate and modules/units that are described above as display elements may be or may not be a physical unit, i.e. in a same location or in various distributed network units. The skilled person in this field can understand that it is possible to select some or all of the units or modules to achieve the purpose of the embodiment.

According to the above description, the skilled person in this field can understand that various embodiments can be implemented by software over a general hardware platform or by hardware. Accordingly, the above technical solution or what is contributed to the prior art may be implemented in the form of software product. The computer software product may be stored in a computer-readable storage medium, for example random access memory (RAM), read only memory (ROM), compact disk (CD), digital versatile disk (DVD) etc. which includes instructions for causing a computing device (e.g. a personal computer, a server or a network device etc.) to perform a method of some or all parts of any one of the above described embodiments.

Finally, it should be noted that the previous embodiments are provided to enable any person skilled in the art to practice the various embodiments of the present disclosure described herein but not to limit these aspects. Though the present disclosure is described by reference to the previous embodiments, various modifications and equivalent features will be readily apparent to those skilled in the art without departing from the spirit and scope of the present disclosure, and the generic principles defined herein may be applied to other aspects or with equivalent features. Thus, the claims are not intended to be limited to the aspects and features shown herein, but are to be accorded the full scope consistent with the language of the claims.

What is claimed is:

1. A bullet screen loading method, applied to a terminal, comprising:
sending a bullet screen request to a server at a preset time interval during playback of a video;
receiving bullet screen data determined by the server according to a time at which the sending apparatus sends the bullet screen request; and
controlling to display the received bullet screen data.

2. The method according to claim 1, further comprising: storing the received bullet screen data and a display time of each bullet screen in the bullet screen data.

3. The method according to claim 1, further comprising: controlling the display apparatus to display each bullet screen according to a display time of the bullet screen.

4. A bullet screen loading method, applied to a server, comprising:
storing bullet screen data of multiple time periods during playback of a video;
receiving a bullet screen request sent by a user terminal;
determining, according to a time at which the user terminal sends the bullet screen request, bullet screen data of a time period within which the time falls; and
sending the determined bullet screen data to the user terminal.

5. A non-transitory computer-readable storage medium storing computer executable instructions, wherein the computer executable instructions are configured to execute a method according to claim 1.

6. An electronic device, comprising:
at least one processor; and
a memory communicably connected with the at least one processor for storing instructions executable by the at least one processor, wherein execution of the instructions by the at least one processor causes the at least one processor to:
send a bullet curtain request to a server at a preset time interval during playback of a video;
receive bullet curtain data determined by the server according to a time at which the sending apparatus sends the bullet curtain request; and
control to display the received bullet curtain data.

7. The electronic device according to claim 6, wherein the at least one processor can further:
store the received bullet curtain data and a display time of each bullet curtain in the bullet curtain data.

8. The electronic device according to claim 6, wherein the at least one processor can further:
control the display apparatus to display each bullet curtain according to a display time of the bullet curtain.
